(19) United States
(12) Patent Application Publication
(10) Pub. No.: US 2019/0063605 A1
(43) Pub. Date: Feb. 28, 2019

(54) ROTARY SEAL

(71) Applicant: Goodrich Actuation Systems Limited, Solihull (GB)

(72) Inventors: Jeremy KRACKE, Stone (GB); Mark TIMMS, Wolverhampton (GB)

(21) Appl. No.: 16/116,978

(22) Filed: Aug. 30, 2018

(30) Foreign Application Priority Data
Aug. 31, 2017 (EP) 17275129.9

(51) Int. Cl. F16J 15/00; F16J 15/3256; F16J 15/3272

(52) U.S. Cl. CPC F16J 15/004; F16J 15/3272; F16J 15/3256

(57) ABSTRACT

There is provided a rotary seal for sealing around shafts in flight controls of an aircraft. The rotary shaft seal comprises: an annular first sealing surface for sealing against a housing; an annular second sealing surface for sealing against a rotatable surface; a reservoir arranged for receiving a fluid that is leaked past the second sealing surface; and a sorbent material within the reservoir for absorbing and/or adsorbing the fluid received within the reservoir. Also provided is a method of sealing around a rotary cylindrical surface within a housing using a rotary seal provided on the cylindrical surface, wherein the rotary seal comprises an annular first sealing surface for sealing against the housing and an annular second sealing surface for sealing against a rotating surface.

### FOREIGN PRIORITY

This application claims priority to European Patent Application No. 17275129.9 filed Aug. 31, 2017, the entire contents of which is incorporated herein by reference.

### TECHNICAL FIELD

The present invention relates to a rotary seal with an integrated leakage collection system. The rotary seal may be applied to any cylindrical surface, such as a rotary surface of a shaft or a seal attached to a shaft. In particular the present invention relates to a rotary seal for sealing shafts in flight controls of an aircraft. The rotary seal may be used, for example, to seal shafts of gearboxes, rotary actuators or secondary actuators within a flight control system of an aircraft.

### BACKGROUND OF THE DISCLOSURE

Rotary seals are used in a number of mechanical systems, such as mechanical actuators and gearboxes, in order to provide a fluid tight seal. A rotary seal is conventionally employed about a shaft which is rotatable within a stationary housing, wherein the shaft protrudes through an opening in the housing. The seal prevents fluid, such as lubricant, from leaking out of the housing around the shaft while also preventing debris, contaminants or other fluids from entering the housing.

Rotary seals may be utilised in aircraft flight control systems, e.g. secondary and primary flight control systems. Aircraft flight control systems employ numerous operating mechanisms to aid in controlling an aircraft's character and direction in flight, for example to operate the secondary control surfaces such as flaps and slats or primary control surfaces of the aircraft, such as ailerons, elevators and rudders, to control the roll, pitch and yaw of the aircraft. Such systems typically employ mechanical systems such as power control units, gearboxes and actuators to convert commands input to the aircraft controls into movement of the relevant control surfaces. These mechanical systems often include rotatable shafts which require sealing to prevent leakage of fluid, and rotary seals are commonly deployed in such systems for this purpose.

The strength of the seal that is provided by a rotary seal is finely tuned to fall between two extremes: zero leakage and long seal life. It is desirable to prevent leakage of fluid as best as possible so that the fluid does not contaminate the surrounding environment. However excessive wear on the seal can occur if the sealing surface of the rotary seal is devoid of lubrication. Without small amounts of fluid penetrating between the sealing surfaces, friction caused by the relative motion of the sealing surfaces can lead to excessive wear on the sealing surfaces of the seal. This can lead to a failure of the seal and a reduction of the working life of the seal. Therefore, to prolong the life span of the seal, typically a small amount of fluid is allowed to leak through the sealing surfaces so as to lubricate the sealing surfaces.

There is a need for an improved rotary seal that enables lubrication of the seal whilst preventing leakage of fluid to the surrounding environment.

### SUMMARY OF THE DISCLOSURE

Viewed from a first aspect, the present disclosure provides a rotary seal for sealing around shafts in flight controls of an aircraft, the rotary seal comprising: an annular first sealing surface for sealing against a housing; an annular second sealing surface for sealing against a rotatable surface; a reservoir arranged for receiving a fluid that is leaked past the second sealing surface; and a sorbent material within the reservoir for absorbing and/or adsorbing the fluid received within the reservoir.

Thus the sorbent material may be an absorbent and/or adsorbent material.

In some embodiments approximately 4.3 cm³ of fluid will leak past the second sealing surface and travel to the reservoir over the lifespan of the rotary seal. Thus, the reservoir may define a volume of less than 4.5 cm³. The reservoir may define a volume of approximately 4.3 cm³.

A point of ingress of fluid to the rotary seal may be formed where the second sealing surface seals against the rotatable surface. A leakage path may be formed within the rotary seal between the point of ingress and the reservoir. Thus, fluid may leak past the second sealing surface and travel along the leakage path to the reservoir. The leakage path may be considered as a leakage passage. It may be a recess within the rotary seal.

Thus, in embodiments, a leakage passage may be provided within the rotary seal between a point of ingress to the rotary seal where the second sealing surface seals against the rotatable surface, and the reservoir. Thus, fluid that may leak past the second sealing surface may travel through the passage to the reservoir.

The first sealing surface and the second sealing surface may be provided by an annular housing seal. The rotary seal may further comprise a further annular seal for sealing against a rotary cylindrical surface within the housing, wherein the further annular seal is rotatable with respect to the housing seal. The rotatable surface may comprise a surface of the further annular seal. Optionally, the reservoir may be arranged between the housing seal and the further annular seal.

Generally, the further annular seal may be considered as a shaft seal and the cylindrical surface may be considered as a shaft. Thus, the shaft seal may be for sealing against a shaft within a housing.

It will be appreciated that, when the rotary seal is installed on a rotary cylindrical surface within a housing, the housing seal generally remains stationary with respect to the housing, and the further annular seal generally rotates with the rotary cylindrical surface. The housing seal may be fixed to the housing, e.g. by an interference fit or friction fit or additionally by means of a retainer or clip attached to the housing. The further annular seal may be fixed to the rotary cylindrical surface, e.g. by an interference fit or friction fit.

The annular housing seal may comprise a radially outer surface for affixing to and sealing against a housing. The further annular seal may comprise a radially inner surface for affixing to and sealing against a rotary cylindrical surface. The radially outer surface of the housing seal may be radially outward of the radially inner surface of the further annular seal.

It will be appreciated that a point of ingress of fluid to the rotary seal may be formed where the second sealing surface seals against the further annular seal. Thus, the above described leakage path, or leakage passage, may be formed within the rotary seal between the point of ingress and the reservoir. The leakage path may be defined between a portion of the housing seal and a portion of the further annular seal.

The sorbent material may be a woven or felted fiber sheet. The sorbent material may comprise fibers of one or more of: cotton, polyester cellulose, nylon, polypropylene, aluminium oxide and wool.

In addition to one or more of the features described above, or as an alternative, the sorbent material may be a powder. The powder may comprise a superabsorbent polymer or aluminium oxide.

In addition to one or more of the features described above, or as an alternative, the sorbent material may be coupled to an internal surface of the rotary seal that defines the reservoir.

In addition to one or more of the features described above, or as an alternative, the second sealing surface may provide a primary sealing mechanism for the rotary seal. The primary sealing mechanism may comprise a self-energised seal or an energised seal having an energiser which provides a sealing force directed radially inwards. In the case that the primary sealing mechanism is an energised seal, optionally, the energiser is a metallic spring or comprises an elastic material, wherein the elastic material may be selected from silicone, fluorocarbons and ethylene propylene diene Monomer (M-class) rubber (EPDM).

In addition to one or more of the features described above, or as an alternative, the rotary seal may be a cassette seal.

In addition to one or more of the features described above, or as an alternative, the housing seal and the further annular seal may each comprise a structural member overmolded with an elastomeric material.

In addition to one or more of the features described above, or as an alternative, the structural members may be made from any one of stainless steel, titanium nitride coated steel, hardened steel, glass fiber reinforced polyether ether ketone (PEEK) or carbon fiber reinforced polyether ether ketone (PEEK).

Additionally or alternatively, the elastomeric material may be any one of carbon fiber reinforced polytetrafluoroethylene (PTFE), aromatic polymer fiber reinforced polytetrafluoroethylene (PTFE), glass fiber reinforced polytetrafluoroethylene (PTFE), fluoroelastomer (FKM), vinyl methyl silicone (VMQ), fluoro silicone (FMQ), ethylene propylene (EP), polyether ether ketone (PEEK), polyurethane (PU), alkyl acrylate copolymer (ACM), acrylonitrile butadiene rubber, nitrile butadiene rubber (NBR) or perfluoroelastomer (FFKM).

In addition to one or more of the features described above, or as an alternative, an inner diameter of the further annular seal is less than 55 mm. In embodiments, the inner diameter of the further annular seal is between 30 mm and 50 mm.

In addition to one or more of the features described above, or as an alternative, an outer diameter of the housing seal is less than 75 mm. In embodiments, the outer diameter of the housing seal is between 50 mm and 70 mm.

In addition to one or more of the features described above, or as an alternative, the rotary seal may further comprise at least one wiper seal arranged to prevent ingress of contaminants into the reservoir. For example, the further annular seal may include a wiper seal at its radially outward end that abuts against an inside surface of the housing seal. It will be appreciated that the placement of the wiper seal would generally be at a point of ingress to the reservoir, generally in a flow path extending from a location external to the housing and into the reservoir. Thus the wiper seal helps avoid contaminants from entering the reservoir, e.g. from a location external to the housing. Additionally, the wiper seal may provide sealing between the further annular seal and the housing seal whilst allowing for relative rotational motion between the further annular seal and the housing seal. Wiper seals may also be known as sliding seals.

Additionally or alternatively, the rotary seal may further comprise at least one wiper seal arranged to prevent egress of contaminants from the reservoir past the second sealing surface. The at least one wiper seal may be located in the above described leakage passage. It will be appreciated that placement of a wiper seal in the leakage passage will provide additional protection to the second sealing surface from contaminants, and help to prevent contaminants from exiting the reservoir in the rotary seal past the second sealing surface and into the housing. Thus, any contaminants that enter the reservoir may be prevented from travelling to the second sealing surface by a wiper seal positioned in the leakage passage. A second wiper seal may be provided in the leakage passage to provide yet further protection from contaminants.

It will be further appreciated that the wiper seal(s) may provide sealing between the further annular seal and the housing seal whilst allowing for relative rotational motion between the further annular seal and the housing seal.

Viewed from a second aspect, the present disclosure provides a method of sealing around a rotary cylindrical surface within a housing using a rotary seal provided on the cylindrical surface, wherein the rotary seal comprises an annular first sealing surface for sealing against the housing and an annular second sealing surface for sealing against a rotating surface, the method comprising: allowing fluid to leak past the second sealing surface for lubrication of the second sealing surface; collecting the fluid in a reservoir within the rotary seal; and absorbing and/or adsorbing the fluid within the reservoir to hold the fluid within the rotary seal and prevent leakage of the fluid out of the reservoir.

The method may use a rotary seal having any of the features described above in relation to the first aspect and embodiments thereof. The rotary seal may comprise an annular housing seal for sealing against the housing and a further annular seal for sealing against the cylindrical surface within the housing. The further annular seal may be rotatable with respect to the housing seal. The housing seal may comprise the first annular sealing surface and the second annular sealing surface, and the rotating surface may comprise a surface of the further annular seal. Optionally, the reservoir may be arranged between the housing seal and the further annular seal.

It will be appreciated that, generally, the housing seal remains stationary with respect to the housing, and the further annular seal rotates with the cylindrical surface.

The fluid collected within the reservoir may be absorbed and/or adsorbed by a sorbent material provided within the reservoir. Preferably, the sorbent material is a woven or felted fiber sheet or a powder.

Viewed from a third aspect, the present disclosure provides an assembly comprising: a shaft and a housing, wherein the shaft extends through an opening in the housing; and a rotary seal according to any of the above described embodiments; wherein the rotary seal is mounted on the shaft for sealing between the shaft and the housing. The assembly may comprise a gearbox.

It will be appreciated that, generally, the housing seal remains stationary with respect to the housing, and the further annular seal rotates with the shaft.

In a further aspect of the present disclosure, there is provided a flight control system comprising an assembly according to any of the above described embodiments.

In yet another aspect of the present disclosure, there is provided a method of installing a rotary seal according to any of the above described embodiments, the method comprising deploying the rotary seal between the outside of a rotary cylindrical surface and an opening in a housing.

The rotary seal may seal against the housing and the rotary cylindrical surface. The rotary cylindrical surface may be a shaft within the housing.

The method may comprise sliding the seal onto the outside of the shaft and pushing the seal along the shaft into an annular gap between the outside of the shaft and the inside of the opening in the housing.

The method may comprise pushing the seal from a side of the seal that is perpendicular to a longitudinal axis of the shaft. The seal will generally be pushed by a pusher. The pusher will generally provide an even pushing force across the side of the seal, e.g. so that the entire seal advances along the shaft at the same rate.

The seal may be held in place on the shaft by a friction fit. A retainer on the housing may be used to hold the seal in place in the housing.

From the above description it will be appreciated that in one aspect the disclosure provides a rotary seal for sealing around shafts in flight controls of an aircraft, the rotary seal comprising: an annular housing seal for sealing against a housing; an annular shaft seal for sealing against a shaft within the housing that is rotatable with respect to the housing seal; wherein the housing seal comprises a sealing surface for sealing against the shaft seal; a reservoir arranged between the housing seal and the shaft seal for receiving a fluid that is leaked past the sealing surface; and a sorbent material within the reservoir for absorbing and/or adsorbing the fluid received within the reservoir.

The various optional features described above are equally applicable to this aspect.

It will also be appreciated that in one aspect, the disclosure provides a method of sealing a rotatable shaft within a housing using a rotary seal provided on the shaft, wherein the rotary seal comprises a shaft seal and a housing seal having a sealing surface for sealing against the shaft seal, the method comprising: allowing fluid to leak past the sealing surface for lubrication of the sealing surface; collecting the fluid in a reservoir within the rotary seal; and absorbing and/or adsorbing the fluid within the reservoir to hold the fluid within the rotary shaft seal and prevent leakage of the fluid out of the reservoir.

The various optional features described above are equally applicable to this aspect.

It will be readily appreciated by the skilled person that the various optional and preferred features of embodiments of the disclosure described above may be applicable to all the various aspects of the disclosure discussed. In particular, features of embodiments of the first aspect may be equally applicable to the method of the second aspect.

### BRIEF DESCRIPTION OF THE FIGURES

Certain preferred embodiments on the present disclosure will now be described in greater detail, by way of example only and with reference to the accompanying drawings, in which:

FIG. 1 illustrates a rotary seal according to an exemplary embodiment of the disclosure;

FIG. 2 is a cross-sectional view of the rotary seal of FIG. 1; and

FIG. 3 shows the rotary seal of FIGS. 1 and 2 installed on a shaft within a housing.

### DETAILED DESCRIPTION

By way of example, the present disclosure is described in the context of a cassette seal for sealing between a rotatable shaft and an opening formed in a housing through which the shaft extends. Whilst a cassette seal is considered to offer advantageous benefits, it is envisaged that other forms of rotary seal may benefit from the subject of this disclosure. For example, the seal may be a lipped seal or any standard energised seal. The seal may e.g. run directly on a shaft, on a surface plated directly on the shaft, or on a sleeve provided on a shaft. Furthermore, it will be appreciated that whilst the present disclosure is discussed in the context of a rotary seal for sealing a shaft, e.g. a shaft in aircraft flight controls, the seal may be applied equally to any cylindrical surface.

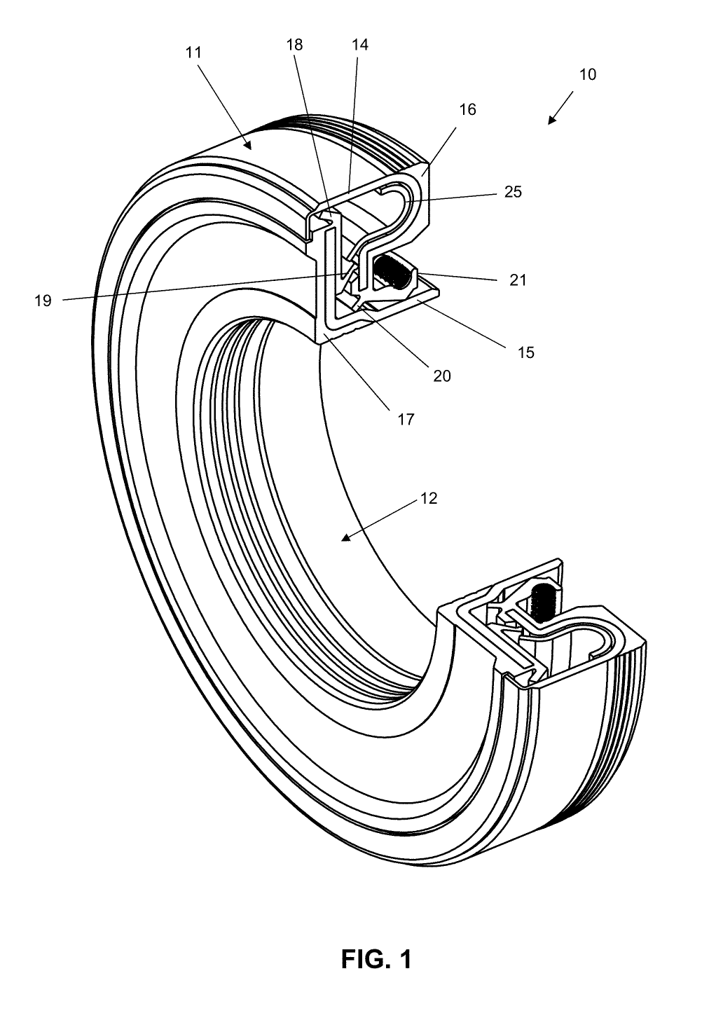

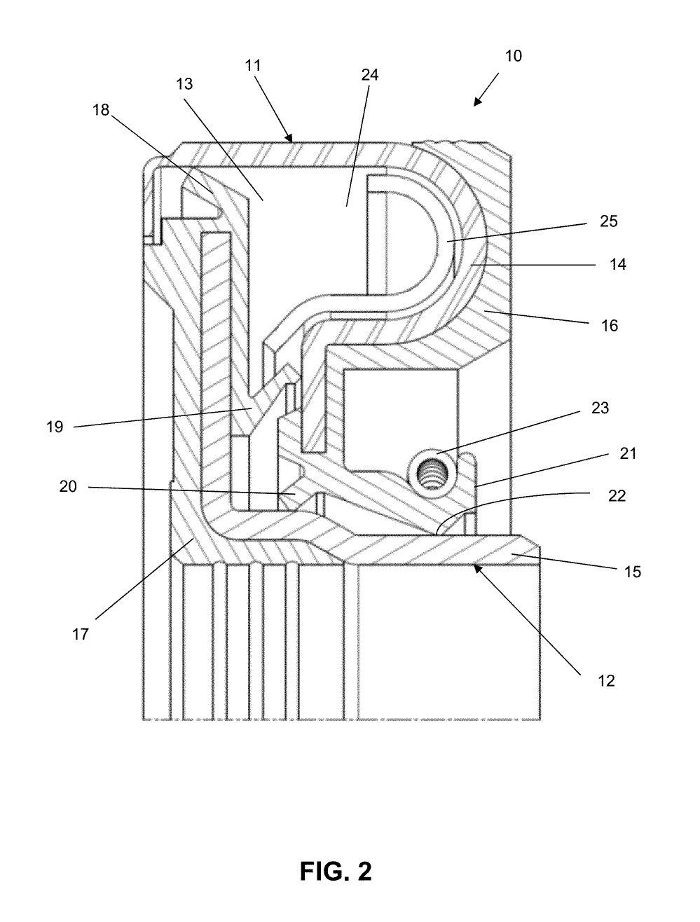

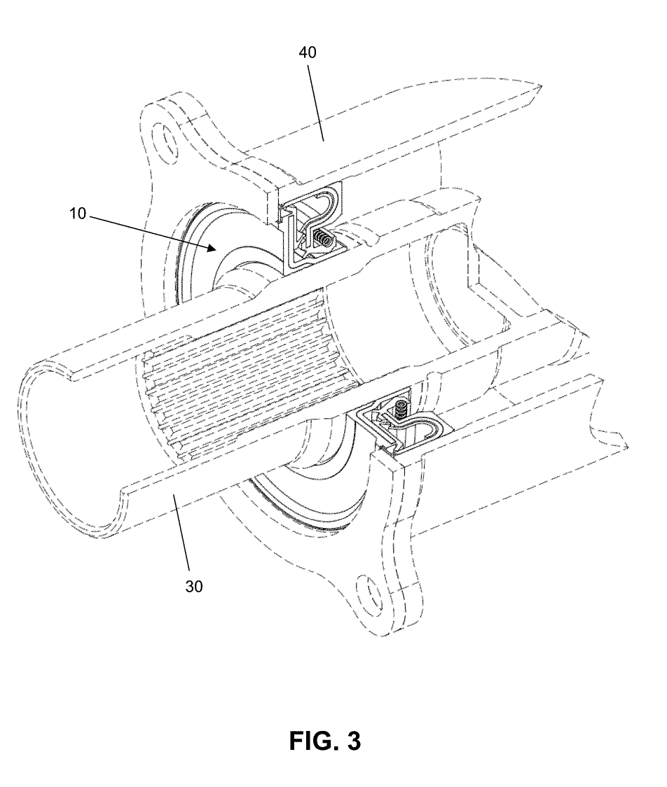

The exemplary rotary seal 10 is shown in FIGS. 1 and 2. In this example, the rotary shaft seal 10 comprises an annular housing seal 11 and a further annular seal. The housing seal 11 has a larger outer diameter than the further annular seal and has an annular first sealing surface for sealing against an inner surface of an opening through which a shaft protrudes. The outer diameter of the housing seal 11, and hence the outer diameter of the rotary seal 10, may be less than about 75 mm. For example, the outer diameter of the rotary seal 10 may be between about 50 mm and about 70 mm. In this exemplary embodiment, the further annular seal is a shaft seal 12. The shaft seal 12 has a smaller inner diameter than the housing seal 11 and is for sealing against a rotary cylindrical surface, in this case a rotatable shaft 30 (see FIG. 3). The inner diameter of the shaft seal 12, and hence the inner diameter of the rotary seal 10, may be less than about 55 mm. For example, the inner diameter of the rotary seal 10 may be between about 30 mm and about 50 mm. These size ranges are appropriate for the rotary seal 10 to be utilised in aircraft flight control systems.

The housing seal 11 and the shaft seal 12 form a single annular sealing unit, i.e. the rotary seal 10. The shaft seal 12 is rotatable with respect to the housing seal 11, and vice versa. In FIG. 3, the rotary seal 10 is shown installed on a shaft 30 within a housing 40. For clarity, the rotary seal 10 is shown in solid lines, while the shaft 30 and the housing 40 are shown in dashed lines. In use, the housing seal 11 is fixed to and seals against the housing 40, whilst the shaft seal 12 is fixed to and seals against the shaft 30. The shaft seal 12 may be fixed to the shaft 30, for example, by interference fit or friction fit. The housing seal 11 may be fixed to the housing 40 by an interference fit or friction fit, and may additionally be fixed to a retainer or clip attached to the housing 40. Thus, the housing seal 11 remains stationary with respect to the housing 40 through which the shaft 30 extends, and the shaft seal 12 rotates with the shaft 30 (i.e. rotates with respect to the housing seal 11 and housing 40). As can be seen from FIG. 2, an internal volume 13 is formed between the shaft seal 12 and the housing seal 11 within the rotary seal 10.

Both the housing seal 11 and the shaft seal 12 include structural (strengthening) members 14, 15 respectively to prevent the rotary seal 10 from deforming. This ensures that reliable fitting of the rotary seal 10 is maintained throughout its working life. In this example, the structural members 14, 15 are formed of stainless steel, however they could also be made from any high strength and high wear resistant materials, for example case hardened materials and corrosion wear resistant materials, such as titanium nitride coated steel or hardened steel.

In order to form a tight seal against a shaft 30 and its housing 40, the structural members 14, 15 are overmolded with an elastomeric material, providing the housing seal 11 and the shaft seal 12 with elastomeric sections 16, 17 respectively. The elastomeric sections 16, 17 provide the rotary seal 10 with deformable surfaces which can deform to match the surfaces of a shaft 30 and shaft housing 40 respectively. In this instance, the elastomeric sections 16, 17 are formed of fluoroelastomer (FKM). Depending on the intended use of the rotary seal 10, it may be subjected to different environments, where different pressures, temperatures and/or types of fluids are experienced. It is therefore anticipated that the elastomeric material of the elastomeric sections 16, 17 may comprise any elastomeric material suitable for the intended use of the rotary seal 10, e.g. suitable for the particular fluid and environment. For example, the elastomeric sections 16, 17 may be made of carbon fiber reinforced polytetrafluoroethylene (PTFE), aromatic polymer fiber reinforced polytetrafluoroethylene (PTFE), glass fiber reinforced polytetrafluoroethylene (PTFE), fluoroelastomer (FKM), vinyl methyl silicone (VMQ), fluoro silicone (FMQ), ethylene propylene (EP), polyether ether ketone (PEEK), polyurethane (PU), alkyl acrylate copolymer (ACM), acrylonitrile butadiene rubber, nitrile butadiene rubber (NBR) or perfluoroelastomer (FFKM).

The elastomeric section 17 of the shaft seal 12 forms a wiper seal 18 abutting against the inside surface of the strengthening member 14 of the housing seal 11 at the radially outward end of the shaft seal 12. The location of abutment of the wiper seal 18 against the inside surface of the strengthening member 14 is at a point of ingress to the internal volume 13. The wiper seal 18 provides sealing between the shaft seal 12 and the housing seal 18 whilst also allowing for relative rotational motion of the shaft seal 12 with respect to the housing seal 18. Thus, the wiper seal 18 helps to prevent dirt and contaminants from entering the internal volume 13, thereby helping prevent dirt or contaminants from travelling through the rotary seal 10 and into the shaft housing 40. Additional wiper seals 19, 20 may also be provided within the rotary seal 10 to reduce the risk of contaminants present in the reservoir 24 from entering the shaft housing 40. As can be seen from FIG. 2, the elastomeric section 17 of the shaft seal 12 may form a wiper seal 19 abutting against the inside surface of the strengthening member 14 of the housing seal 12 at a location within the internal volume 13. Additionally or alternatively, the elastomeric section 16 of the housing seal 11 may form a wiper seal 20 abutting against the inside surface of the strengthening member 15 of the shaft seal 12 at a location within the internal volume 13. As with the wiper seal 18, the additional wiper seals 19, 20 enable further sealing between the shaft seal 12 and the housing seal 18 whilst allowing for relative rotational motion of the shaft seal 12 with respect to the housing seal 18. The additional wiper seals 19, 20 aid in preventing dirt and contaminants that have entered the internal volume 13 from travelling into the shaft housing 40.

A primary sealing mechanism 21 for sealing against a rotatable shaft is provided by a spring energised seal. At a radially inner side of the housing seal 11, the elastomeric section 16 extends axially from the structural member 14 and provides the housing seal 11 with an annular second sealing surface. In this case the second sealing surface is a sealing surface 22 that contacts a radially outer surface of the strengthening member 15 of the shaft seal 12. An energiser 23 is provided on a radially outer surface of the sealing surface 22 to provide a sealing force directed radially inwards. In this exemplary embodiment, the energiser 23 is a metallic spring. In alternative embodiments, the energiser 23 may be made of any elastic material, for example, silicone, fluorocarbons or ethylene propylene diene Monomer (M-class) rubber (EPDM). The elastic material will generally be chosen to be compatible with the fluid that is being sealed.

Alternatively, the primary sealing mechanism 21 may be provided by a self-energised seal. For example, the elastomeric material 16 forming the sealing surface 22 may be formed so that its inner diameter is smaller than the diameter of the radially outer surface of the strengthening member 15 of the shaft seal 12. The elasticity of the elastomeric material 16 would therefore provide a sealing force directed radially inwards towards the outer surface of the strengthening member 15.

With reference to FIG. 2, it can be seen that the internal volume 13 forms a reservoir 24 within the rotary seal 10. When in use, it is desirable for a small amount of fluid to enter the internal volume 13 through the primary sealing mechanism 21. For example, a volume of fluid in the region of one drop may pass through the primary sealing mechanism 21 for every 1000 rotations of the shaft 30. It is noted that a “drop” is a known unit of measure typically used as a visual guide. It will be appreciated that the volume of a “drop” is dependent on the properties of the liquid being measured, for example its viscosity and temperature. In one example, 15.4 drops may be equal to approximately 1 cm³, i.e. 1 drop is approximately 0.065 cm³. Alternatively, a volume of fluid in the region of 1 cm³ may pass through the primary sealing mechanism 21 for every 14000 rotations of the shaft 30. In such an embodiment, the shaft may be an intermittent use fully reversing diameter 35 shaft with mineral oil lubrication and 1.45 m/s maximum surface speed.

This fluid acts to lubricate the primary sealing mechanism 21, preventing excessive wear of the sealing surface 22 caused by the sealing surface 22 rubbing against the strengthening member 15 of the shaft seal 12 as the shaft seal 12 rotates with the shaft. By reducing the wear on the sealing surface 22, the rotary seal 10 is less likely to fail and the working life of the rotary seal 10 is prolonged. The fluid enters the rotary seal 10 through the primary sealing mechanism 21 and then moves to the reservoir 24.

Thus a point of ingress of fluid to the rotary seal 10 is formed where the sealing surface 22 seals against the shaft seal 12. A leakage path is formed within the rotary seal 10 between the point of ingress and the reservoir 24 so that fluid can leak past the sealing surface 22 and travel along the leakage path to the reservoir 24. The leakage path may be considered as a leakage passage. In this embodiment it is a recess within the rotary seal 10 defined between a portion of the housing seal 11 and a portion of the shaft seal 12.

In embodiments that also include wiper seal 19 and/or wiper seal 20, these may be located in the leakage path. The fluid enters the rotary seal 10 through the primary sealing mechanism 21 and passes through the wiper seals 19, 20 before moving to the reservoir 24. The additional wiper seals 19, 20 also help to prevent dirt and contaminants from reaching the primary sealing mechanism 21, reducing the wear on the sealing surface 22 that such contaminants may cause.

The wiper seal 18 is designed to prevent ingress of dirt or contaminants into the internal volume 13, and is not primarily designed to prevent fluid from leaking from the reservoir 24 and out of the rotary seal 10. Therefore, there is potential for fluid to leak past the wiper seal 18.

To prevent fluid from leaking from the rotary seal 10, a sorbent material 25 is placed within the reservoir 24 to hold the fluid and trap it within the rotary seal 10. The sorbent material 25 may be attached to an interior wall of the housing seal 11, within the reservoir 24. Additionally, or alternatively, the sorbent material 25 may fill the reservoir 24. By filling the reservoir 24 with the sorbent material 25, dirt and contaminants that enter the internal volume 13 past the wiper seal 18 may also be trapped by the sorbent material 25 and prevented from leaving the reservoir 24 and entering the shaft housing.

In this exemplary embodiment, the sorbent material 25 is a woven or felted fiber sheet affixed to the interior wall of the housing seal 11. The sorbent material 25 may for example comprise fibers of cotton, nylon, polypropylene or wool. The sorbent material 25 may alternatively be a powder which coats the interior walls of the reservoir 24 or is packed within the reservoir 24. The powder may comprise for example, a superabsorbent polymer or aluminium oxide. The type of sorbent material 25 used within the rotary seal 10 may depend on the fluid that is to be absorbed and/or adsorbed. For example, the sorbent material 25 may be a material suitable for absorbing and/or adsorbing semi-fluid grease (i.e. a low viscosity grease) and/or semi-fluid oil. Such semi-fluids may be used, for example, in gearboxes for lubrication purposes.

The reservoir 24 and sorbent material 25 are made large enough to collect and hold the volume of fluid expected to pass through the primary sealing mechanism 21 throughout the lifespan of a fully functioning rotary seal 10. Therefore, there is no need to empty the reservoir 24, or replace the sorbent material 25, before the rotary seal 10 would be expected to be replaced due to wearing out of the primary sealing mechanism 21 or other age related defects. It is anticipated that approximately 4.3 cm³ of fluid may pass through the primary sealing mechanism 21 and travel to the reservoir 24 over the lifespan of the rotary seal 10. Thus, the reservoir 24 may have a total volume of 4.3 cm³.

The sorbent material 25 placed within the reservoir 24 prevents leakage of fluid from the interior of the housing and through the rotary seal 10, whilst allowing a small amount of fluid to pass through the primary sealing mechanism 21 in order to provide lubrication of the primary sealing mechanism 21. The reservoir 24 and the sorbent material 25 are integral to the rotary seal 10 therefore there is no need for an external leakage collection system. Such collection systems may become detached from the rotary seal 10 during use which would clearly be highly problematic. For example, vibrations in the mechanical system may cause a collection system to disconnect, causing leakage of fluid.

The rotary seal 10 may form a component of a mechanical system, for example a gearbox or actuator of a flight control system of an aircraft. The rotary seal 10 may need to be replaced at service intervals of the mechanical system if tests indicate that the rotary seal 10 has become worn or is otherwise defective. The rotary seal 10 forms an integral unit that can be tested and certified at the factory prior to shipping to customers. Therefore, the rotary seal 10 may be replaced, in the field, without having to re-test and re-certify the assembled mechanical system. This can simplify maintenance of the mechanical system, avoiding potentially lengthy testing of the system which may require the system to be out of action for a prolonged period of time, and also allows for repairs to be carried out in the field without having to ship the system back to the factory for extensive maintenance and testing.

As will be appreciated from the above description, in use, the housing seal 11 is fixed to the housing 40 through which a shaft 30 extends. The housing seal 11 therefore remains stationary with respect to the housing 40. The shaft seal 12 is fixed to the shaft 30 and rotates with the shaft 30. Thus, the shaft seal 12 rotates with respect to the housing seal 11. The rotary seal 10 prevents fluid within the housing 40 from leaking out of the opening in the housing 40 around the shaft 30. In FIG. 2, the interior of the housing 40 is considered as being on the right of the rotary seal 10, whilst a region external to the housing 40 is considered as being on the left of the rotary seal 10.

A leakage path, or passage, is formed that allows fluid from within the housing 40 to enter the rotary seal 10. A small amount of fluid from the housing 40 is allowed to leak past the primary sealing mechanism 21 to enter the internal volume 13, providing lubrication for the sealing surface 22 of the primary sealing mechanism 21. The fluid then flows into the reservoir 24. In embodiments where the rotary seal 10 includes wiper seal 19 and/or wiper seal 20, the fluid enters the rotary seal 10 through the primary sealing mechanism 21 and then flows past the wiper seals 19, 20 before entering the reservoir 24.

Within the reservoir, the fluid is absorbed and/or adsorbed by the sorbent material 25. Thus, the fluid is held in or on the sorbent material 25 and prevented from leaking past the wiper seal 18 and out of the rotary seal 10. Thus, the disclosure provides the significant advantage of enabling lubrication of the sealing surface whilst preventing leaked fluid from contaminating the surrounding environment.

In the event that dirt and contaminants from outside the housing enter the rotary seal 10 past the wiper seal 18, the sorbent material 25 may act to trap the dirt and contaminants within the reservoir 24 and/or internal volume 13. Furthermore, wiper seal 19 and/or wiper seal 20 may be provided to help prevent the flow of dirt and contaminants from the reservoir 24 to the primary sealing mechanism 21.

1. A rotary seal for sealing around shafts in flight controls of an aircraft, the rotary seal comprising:
an annular first sealing surface for sealing against a housing;
an annular second sealing surface for sealing against a rotatable surface;
a reservoir arranged for receiving a fluid that is leaked past the second sealing surface; and
a sorbent material within the reservoir for absorbing and/or adsorbing the fluid received within the reservoir.

2. The rotary seal of claim 1, wherein the first sealing surface and the second sealing surface are provided by an annular housing seal and wherein the rotary seal further comprises a further annular seal for sealing against a rotary cylindrical surface within the housing, the further annular seal being rotatable with respect to the housing seal;
wherein the rotatable surface comprises a surface of the further annular seal;
preferably wherein the reservoir is arranged between the housing seal and the further annular seal.

3. The rotary seal of claim 1, wherein the sorbent material is a woven or felted fiber sheet or a powder
preferably wherein when the sorbent material is a woven or felted fiber sheet the sorbent material comprises fibers of one or more of: cotton, nylon, polypropylene and wool.

4. The rotary seal of claim 1, wherein when the sorbent material is a powder that comprises a superabsorbent polymer or aluminium oxide.

5. The rotary seal of claim 3, wherein the sorbent material is coupled to an internal surface of the rotary seal that defines the reservoir.

6. The rotary seal of claim 1, wherein the second sealing surface provides a primary sealing mechanism for the rotary seal, the primary sealing mechanism comprising a self-energised seal or an energised seal having an energiser which provides a sealing force directed radially inwards.

7. The rotary seal of claim 6, wherein when the primary sealing mechanism is an energised seal the energiser is a metallic spring or comprises an elastic material selected from silicone, fluorocarbons and ethylene propylene diene Monomer (M-class) rubber (EPDM).

8. The rotary seal of claim 1, wherein the rotary seal is a cassette seal.

9. The rotary seal of claim 1, wherein the housing seal and the further annular seal each comprise a structural member overmolded with an elastomeric material.

10. The rotary seal of claim 9, wherein the structural members are made from any one of stainless steel, titanium nitride coated steel, hardened steel, glass fiber reinforced polyether ether ketone (PEEK) or carbon fiber reinforced polyether ether ketone (PEEK).

11. The rotary seal of claim 10, wherein the elastomeric material is any one of carbon fiber reinforced polytetrafluoroethylene (PTFE), aromatic polymer fiber reinforced polytetrafluoroethylene (PTFE), glass fiber reinforced polytetrafluoroethylene (PTFE), fluoroelastomer (FKM), vinyl methyl silicone (VMQ), fluoro silicone (FMQ), ethylene propylene (EP), polyether ether ketone (PEEK), polyurethane (PU), alkyl acrylate copolymer (ACM), acrylonitrile butadiene rubber, nitrile butadiene rubber (NBR) or perfluoroelastomer (FFKM).

12. The rotary seal of claim 9, wherein the elastomeric material is any one of carbon fiber reinforced polytetrafluoroethylene (PTFE), aromatic polymer fiber reinforced polytetrafluoroethylene (PTFE), glass fiber reinforced polytetrafluoroethylene (PTFE), fluoroelastomer (FKM), vinyl methyl silicone (VMQ), fluoro silicone (FMQ), ethylene propylene (EP), polyether ether ketone (PEEK), polyurethane (PU), alkyl acrylate copolymer (ACM), acrylonitrile butadiene rubber, nitrile butadiene rubber (NBR) or perfluoroelastomer (FFKM).

13. The rotary seal of claim 2, wherein an inner diameter of the further annular seal is less than 55 mm, preferably between 30 mm and 50 mm, or wherein an outer diameter of the housing seal is less than 75 mm, preferably between 50 mm and 70 mm.

14. The rotary seal of claim 1, wherein the rotary seal further comprises at least one wiper seal arranged to prevent ingress of contaminants into the reservoir, wherein the rotatory seal further comprises at least one wiper seal arranged to prevent egress of contaminants from the reservoir past the second sealing surface.

15. A method of sealing around a rotary cylindrical surface within a housing using a rotary seal provided on the cylindrical surface, wherein the rotary seal comprises an annular first sealing surface for sealing against the housing and an annular second sealing surface for sealing against a rotating surface, the method comprising:
allowing fluid to leak past the second sealing surface for lubrication of the second sealing surface;
collecting the fluid in a reservoir within the rotary seal; and
absorbing and/or adsorbing the fluid within the reservoir to hold the fluid within the rotary seal and prevent leakage of the fluid out of the reservoir.

16. The method of claim 15, wherein the rotary seal comprises an annular housing seal for sealing against the housing and a further annular seal for sealing against the cylindrical surface within the housing, the further annular seal being rotatable with respect to the housing seal;
wherein the housing seal comprises the first annular sealing surface and the second annular sealing surface, and wherein the rotating surface comprises a surface of the further annular seal;
preferably wherein the reservoir is arranged between the housing seal and the further annular seal.

17. The method of claim 16, wherein the fluid collected within the reservoir is absorbed and/or adsorbed by a sorbent material provided within the reservoir, preferably wherein the sorbent material is a woven or felted fiber sheet or a powder.

18. An assembly comprising:
a shaft and a housing, wherein the shaft extends through an opening in a housing; and
a rotary seal that includes:
an annular first sealing surface for sealing against a housing;
an annular second sealing surface for sealing against a rotatable surface;
a reservoir arranged for receiving a fluid that is leaked past the second sealing surface; and
a sorbent material within the reservoir for absorbing and/or adsorbing the fluid received within the reservoir; wherein the rotary seal is mounted on the shaft for sealing between the shaft and the housing.

19. A flight control system comprising an assembly as claimed in claim 18.
